(19) United States
(12) Patent Application Publication
(10) Pub. No.: US 2006/0062543 A1
(43) Pub. Date: Mar. 23, 2006

(54) Recording apparatus for automatically limiting settable recording time and method thereof

(75) Inventor: Jin-hwi Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/196,471

(22) Filed: Aug. 4, 2005

(30) Foreign Application Priority Data
Sep. 20, 2004 (KR) 2004-75007

(51) Int. Cl. H04N 5/76; H04N 5/781

(52) U.S. Cl. 386/46; 386/125

(57) ABSTRACT

A recording apparatus for automatically limiting a settable recording time and method thereof. The recording apparatus includes: a calculator to calculate a recordable time of the recording medium, a manipulator to set a recording time, an on-screen display (OSD) processor to OSD-process information, and a controller to record the input video with the recording time unspecified and to control the OSD processor to OSD-process information indicating the unspecified recording time when the recording time exceeds the recordable time. Accordingly, as the user cannot set the recording time over the recordable time of the recording medium.

### CROSS-REFERENCE TO RELATED APPLICATION

This application claims the benefit under 35 U.S.C. § 119 (a) of Korean Patent Application No. 2004-75007 filed on Sep. 20, 2004 in the Korean Intellectual Property Office, the entire disclosure of which is incorporated herein by reference.

### BACKGROUND OF THE INVENTION

1. Field of the Invention

The present invention relates to a recording apparatus, and more specifically, to a recording apparatus to record an input video on a recording medium.

2. Description of Related Art

A recording apparatus records an input video on a recording medium. A typical example of the recording apparatus is a video cassette recorder (VCR).

Most VCRs coming to the market use a one-touch recording (OTR) feature. The OTR feature facilitates the recording for a recording time specified by a user. When the recording time is not specified, the recording is continued (i.e., continuously performed).

The OTR feature allows a user to use a recording button alone to set either a desired recording time or a continuous recording function which records with the recording time unspecified. While the VCR is stopped, the selection of the recording button sets the continuous recording. One more selection of the recording button sets 30-minute recording (hereinafter, referred to as a 0:30 recording). Further selection of the recording button sets 1:00 recording. Subsequently, following selections of the recording button recursively set 1:30 recording→2:00 recording→2:30 recording→ . . . 6:00 recording→continuous recording→0:30 recording→ . . . , and so forth.

As the OTR feature facilitates the selection of the desired recording time or the continuous recording via the single recording button, the user enjoys increased convenience of recording.

To execute the recording for the recording time fixed by the user, there should be unoccupied recording area corresponding to the fixed recording time on a recording medium such as a VCR tape. However, not knowing whether there is a sufficient unoccupied recording area on the recording medium, the user cannot consider the unoccupied recording area at all when setting the recording time.

As a result, the unoccupied recording area equivalent to the set recording time may be insufficient to record the entire input video that the user wants to record. This deficiency causes less than the entire input video to be recorded.

### BRIEF SUMMARY

An aspect of the present invention provides a recording apparatus to automatically limit a settable recording time to below a recordable time of a recording medium, and a method to limit the application recording time.

According to an aspect of the present invention, there is provided a recording apparatus for recording an input video on a recording medium, including: a calculator calculating a recordable time of the recording medium; a manipulator setting a recording time; an on-screen display (OSD) processor OSD processing information; and a controller controlling recording of the input video with the recording time unspecified and controlling the OSD processor to OSD-process information indicating the unspecified recording time when the recording time exceeds the recordable time.

The recording time can be set according to a one-touch record (OTR) feature.

The calculator may calculate the recordable time based on a recording area of the recording medium and a predetermined recording speed.

The recording medium may be one of an optical recording medium, a magnetic recording medium, a semiconductor recording medium, a compact disk (CD), a digital video disk (DVD), a hard disk drive (HDD), a tape, and a memory card.

According to another aspect of the present invention, there is provided a method for automatically limiting a recording time at a recording apparatus that records an input video on a recording medium, including: calculating a recordable time of the recording medium; setting a recording time; and recording the input video with the recording time unspecified, and on-screen display (OSD)-processing information indicating that the unspecified recording time when the recording time exceeds the recordable time.

The recording time can be set according to a one-touch record (OTR) feature.

The recordable time may be calculated based on a recording area of the recording medium and a predetermined recording speed.

The recording apparatus may be an optical recorder, a magnetic recorder, a semiconductor recorder, a compact disk recorder (CDR), a digital disk recorder (DVDR), a hard disk drive (HDD) recorder, a video cassette recorder (VCR), or a memory card recorder.

According to another aspect of the present invention, there is provided a recording apparatus, including: a user interface to receive a recording duration command; a recorder recording a received input video onto a loaded recording medium; a calculator calculating an available recording time of the recording medium; an on-screen display (OSD) processor generating and OSD-processing information to be displayed; and a controller controlling the recorder and the OSD processor so that, when the recording duration exceeds the available recordable time, the recorder continuously records the input video with an unspecified duration and information indicating the continuous recording is OSD-processed.

According to another aspect of the present invention, there is provided a recording method, including: recording a received input video onto a loaded recording medium in response to a received recording duration command; calculating an available recording time of the recording medium; generating and OSD-processing text information to be displayed; and controlling a recorder and an OSD processor so that, when the recording duration exceeds the available recordable time, the recorder continuously records the input video with an unspecified duration and information indicating the continuous recording is OSD-processed.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a recording apparatus to automatically limit a settable recording time according to an embodiment of the present invention;

FIG. 2 is a flowchart of operations to automatically limit the settable recording time at the recording apparatus as shown in FIG. 1;

FIG. 3A through FIG. 3E are TV screens showing OSD-processed information.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

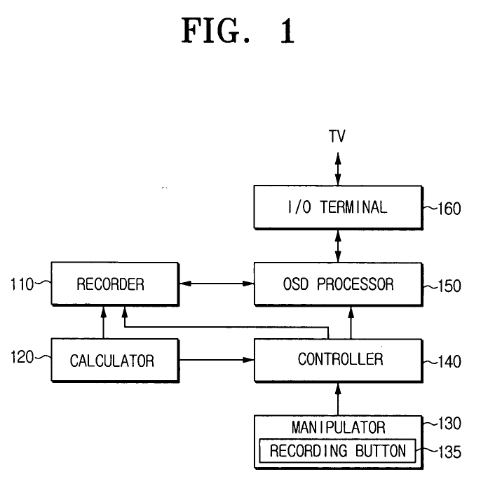

FIG. 1 is a block diagram of a recording apparatus for automatically limiting a settable recording time according to an embodiment of the present invention.

Initially, it is to be understood that various recording apparatuses can be used in the present embodiment.

The recording apparatus records an input video on a recording medium. Non-limiting examples of various types of recording apparatuses include an optical recording apparatus, a magnetic recording apparatus, a semiconductor recording apparatus, and the like. Non-limiting examples of an optical recording apparatus include a compact disk recorder (CDR) and a digital video disk recorder (DVDR). Non-limiting examples of a magnetic recording apparatus include a hard disk driver (HDD) recorder and a video cassette recorder (VCR). A non-limiting example of a semiconductor recording apparatus is a memory card recorder.

Referring now to FIG. 1, the recording apparatus according to an embodiment of the present invention includes a recorder 110, a calculator 120, a manipulator 130, a controller 140, an on-screen display (OSD) processor 150, and an input and output (I/O) terminal 160.

The recorder 110 records an input video, which is received from, by way of a non-limiting example, a TV being an external device through the I/O terminal 160, explained in detail below, on a loaded recording medium (not shown). As various recording apparatuses may be used in the present embodiment, various recording media can be loaded in the recorder 110. Non-limiting examples of the various recording media include an optical recording medium such as a CD, a DVD, a magnetic recording medium such as a HDD, a tape, and a semiconductor such as a memory card.

The calculator 120 calculates a recordable time of the recording medium loaded in the recorder 110. The recordable time is a time period converted from a length of the input video recordable on the recording medium. The calculator 120 calculates the recordable time based on a recording area of the recording medium and a predetermined recording speed. Accordingly, as the recording speed varies with the recordable area fixed, the recordable time obtained at the calculator 120 also changes. Alternatively, the controller 140, explained in detail below, may perform the calculation instead of the calculator 120. In this case, the calculator 120 can be omitted.

The manipulator 130 is a user interface to forward a user's manipulation command to the controller 140 in a manner described below. The manipulator 130 may be realized by a manipulation panel provided at the front part of the recording apparatus and a remote controller operable from a distance.

The manipulator 130 is used to set a desired recording time. The user utilizes a recording button 135 provided at the manipulator 130 to set his/her desired recording time or a continuous recording according to one-touch record (OTR) feature.

The OSD processor 150 creates and OSD-processes text information to be displayed on a TV screen. The I/O terminal 160 is connected with an external device such as a TV.

The controller 140 controls the recording at the recorder 110 and the OSD processing at the OSD processor 150. When the recording time set through the manipulator 130 exceeds the recordable time calculated at the calculator 120, the controller 140 controls to record the input video with the recording time unspecified, that is, to set a continuous recording. In this situation, the controller 140 controls the OSD processor 150 to OSD-process information indicating that the unspecified recording time, that is, the continuous recording.

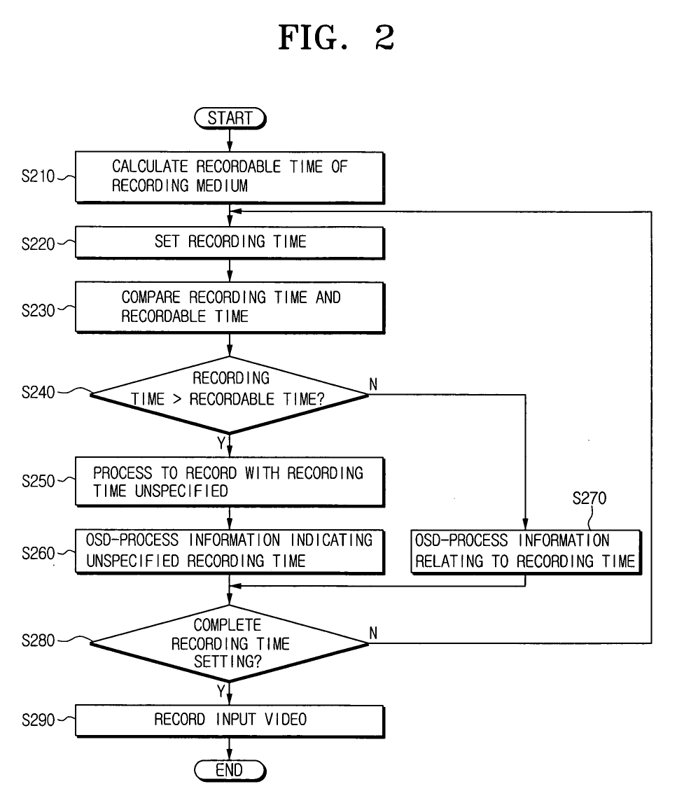

In the following description, a method of limiting the settable recording time at the recording apparatus is illustrated in reference to FIG. 2. FIG. 2 is a flowchart explaining operations to automatically limit a settable recording time at a recording apparatus. The method of FIG. 2 can be performed by the apparatus of IFG. 1 and is, for ease of explanation only, described in conjunction with the apparatus of FIG. 1. However, it is to be understood that the method of FIG. 2 can be performed by apparatuses of other configurations and vice versa.

The calculator 120 calculates the recordable time of the recording medium loaded in the recorder 110 (S210). The user specifies a desired recording time by use of the recording button 135 of the manipulator 130 according to the OTR feature (S220). The calculated recordable time at operation S210 and the set recording time at operation S220 are provided to the controller 140. Note that operations S210 and S220 may be changed with each other.

The controller 140 compares the recording time and the recordable time (S230). When it is determined that the recording time exceeds the recordable time (S240), the controller 140 processes to record with the recording time unspecified, that is, to set the continuous recording (S250). This is because the entire input video cannot be recorded on the recording medium for the recording time set at operation S220.

The controller 140 controls the OSD processor 150 to OSD-process the information indicating the unspecified recording time, that is, indicating the continuous recording (S260). The OSD-processed information is displayed on the TV screen. Thus, upon seeing the OSD-processed information on the TV screen, the user can perceive that it is impossible to record the entire input video for the recording time set at operation S220, and obtain the recordable time of the recording medium.

By contrast, when it is determined that the recording time is below (i.e., less than) the recordable time (S240), the controller 140 keeps the specified recording time and controls the OSD processor 150 to OSD-process the information relating to the specified recording time (S270).

Next, when the completion of the recording time setting is determined (S280), the controller 140 controls the recorder 110 to record the input video on the recording medium according to the specified recording time at operation S220 or the unspecified recording time at operation S250 (S290). If the recording button 135 of the manipulator 130 is not selected within a certain time, it is regarded that the recording time setting is finished.

Otherwise, when the incompletion of the recording time setting is determined (S280), operations S220 through S270 are repeated. If the recording button 135 of the manipulator 130 is selected within the certain time, it is regarded that the recording time setting is not finished yet.

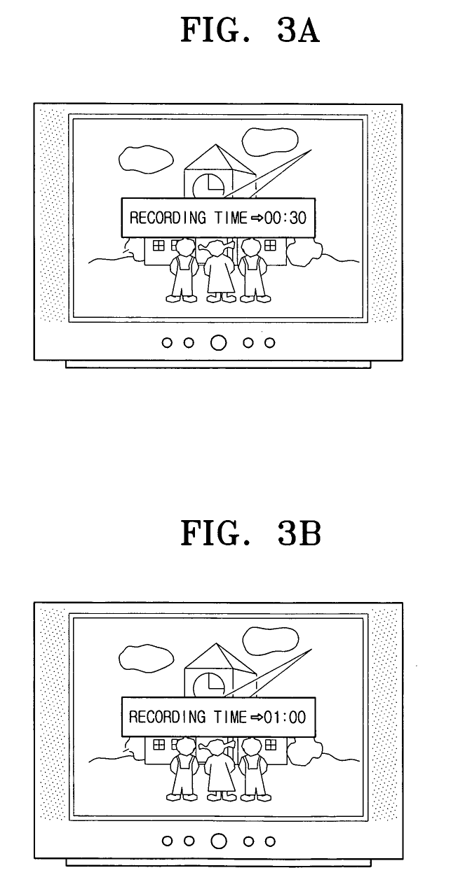

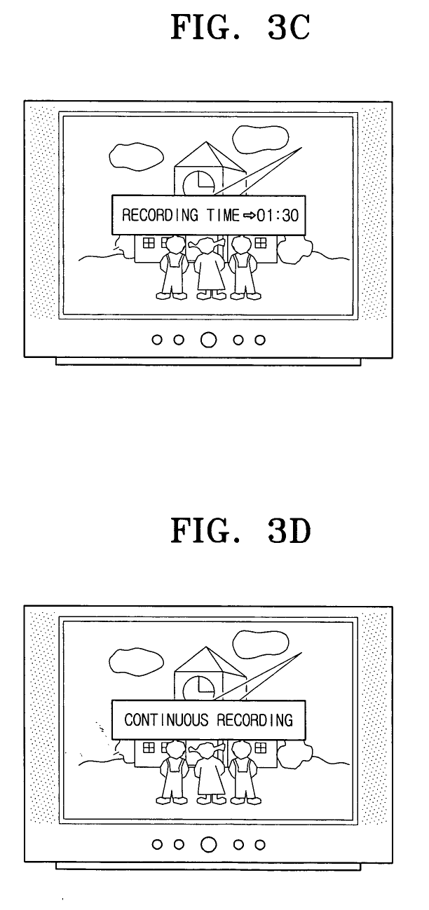

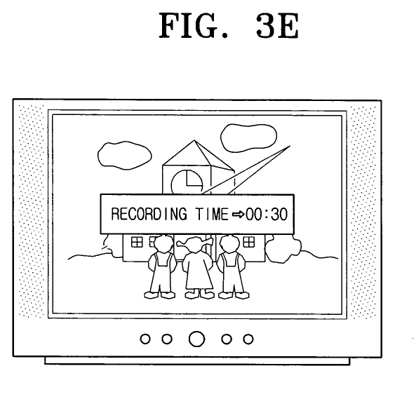

Further descriptions are made of the method of automatically limiting the settable recording time at the recording apparatus with reference to FIGS. 2 and 3A through FIG. 3E.

FIGS. 3A through 3E depict the OSD-processed information (hereinafter, referred to as OSD information) displayed on the TV screen in order when the user sets the recording time using the recording button 135 according to the OTR feature, given that the recordable time 1:30 is obtained at operation S210.

As shown in FIGS. 3A through 3E, the OSD information displayed on the TV screen is changed from ‘recording time [symbol] 0:30’ (FIG. 3A)→‘recording time [symbol] 1:00’ (FIG. 3B)→‘recording time [symbol] 1:30’ (FIG. 3C)→‘continuous recording’ (FIG. 3D)→‘recording time [symbol] 0:30’ (FIG. 3E).

Originally, the OSD information on the TV screen in FIG. 3D should be ‘recording time [symbol] 2:00’. Instead, the OSD information continuous recording is displayed because it is determined that the recording time 2:00 exceeds the recordable time 1:30 at operation S240 in FIG. 2. More specifically, the controller 140 processes to record with the recording time unspecified, that is, to set the continuous recording at operation S250 in FIG. 2, and controls the OSD processor 150 to OSD-process the information relating to the unspecified recording time at operation S260 in FIG. 2.

According to the above-described embodiments of the present invention, it is possible to automatically limit the recording time set by the user to below the recordable time of the recording medium. Accordingly, as the user cannot set the recording time over the recordable time of the recording medium, the above-described embodiments of the present invention can prevent the user's desired input video from being unrecorded as a whole. Furthermore, the OSD information enables the user to perceive that it is impossible to record the entire input video for the user's set recording time, and to know the recordable time of the loaded recording medium.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A recording apparatus for recording an input video on a recording medium, comprising:
a calculator calculating a recordable time of the recording medium;
a manipulator setting a recording time;
an on-screen display (OSD) processor OSD-processing information; and
a controller controlling recording of the input video with the recording time unspecified and controlling the OSD processor to OSD-process information indicating the unspecified recording time when the recording time exceeds the recordable time.

2. The recording apparatus of claim 1, wherein the recording time is set according to a one-touch record (OTR) feature.

3. The recording apparatus of claim 1, wherein the calculator calculates the recordable time based on a recording area of the recording medium and a predetermined recording speed.

4. The recording apparatus of claim 1, wherein the recording medium is an optical recording medium, a magnetic recording medium, a semiconductor recording medium, a compact disk (CD), a digital video disk (DVD), a hard disk drive (HDD), a tape, or a memory card.

5. A method of automatically limiting a recording time at a recording apparatus that records an input video on a recording medium, comprising:
calculating a recordable time of the recording medium;
setting a recording time; and
recording the input video with the recording time unspecified, and on-screen display (OSD)-processing information indicating that the unspecified recording time when the recording time exceeds the recordable time.

6. The method of claim 5, wherein the recording time is set according to a one-touch record (OTR) feature.

7. The method of claim 6, wherein the recordable time is calculated based on a recording area of the recording medium and a predetermined recording speed.

8. The method of claim 6, wherein the recording apparatus is an optical recorder, a magnetic recorder, a semiconductor recorder, a compact disk recorder (CDR), a digital disk recorder (DVDR), a hard disk drive (HDD) recorder, a video cassette recorder (VCR), or a memory card recorder.

9. A recording apparatus, comprising:
a user interface to receive a recording duration command;
a recorder recording a received input video onto a loaded recording medium;
a calculator calculating an available recording time of the recording medium;
an on-screen display (OSD) processor generating and OSD-processing information to be displayed; and
a controller controlling the recorder and the OSD processor so that, when the recording duration exceeds the available recordable time, the recorder continuously records the input video with an unspecified duration and information indicating the continuous recording is OSD-processed.

10. The recording apparatus of claim 9, wherein the user interface is a manipulation panel or a remote control.

11. The recording apparatus of claim 10, wherein the user interface includes a recording button to set the recording duration or continuous recording according to a one-touch record (OTR) feature.

12. A recording method, comprising:
recording a received input video onto a loaded recording medium in response to a received recording duration command;
calculating an available recording time of the recording medium;
generating and OSD-processing text information to be displayed; and
controlling a recorder and an OSD processor so that, when the recording duration exceeds the available recordable time, the recorder continuously records the input video with an unspecified duration and information indicating the continuous recording is OSD-processed.
